(19) United States
(12) Patent Application Publication
(10) Pub. No.: US 2008/0076426 A1
(43) Pub. Date: Mar. 27, 2008

(54) APPARATUS AND METHOD FOR EXECUTING HANDOVER BASED ON USER DECISION

(75) Inventor: Seung-Hoon Nam, Hwadeong-si (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (KR)

(21) Appl. No.: 11/862,860

(22) Filed: Sep. 27, 2007

(30) Foreign Application Priority Data
Sep. 27, 2006 (KR) 2006-0094091

(51) Int. Cl. H04Q 7/20; H04Q 7/00

(52) U.S. Cl. 455/436; 370/331; 455/552.1

(57) ABSTRACT

Provided is an apparatus and method for performing hand-out from a UMA network to a GSM/GPRS network based on a user decision, or performing hand-in from the GSM/GPRS network to the UMA network. The hand-out starts with an input of a hand-out key directing hand-out into the GSM/GPRS network from a user during voice communication through the UMA network. Then, a handover request message is transmitted to a UMA base station, and a handover command message is received in response.

### PRIORITY

This application claims priority under 35 U.S.C. § 119 to an application filed in the Korean Intellectual Property Office on Sep. 27, 2006 and assigned Serial No. 2006-94091, the contents of which are incorporated herein by reference.

### BACKGROUND OF THE INVENTION

1. Field of the Invention

The present invention relates generally to handover, and in particular, to an apparatus and method for executing a hand-out function from a Unlicensed Mobile Access (UMA) network to a Global System for Mobile Communication (GSM)/General Packet Radio Service (GPRS) network based on a user decision, or executing a hand-in function from the GSM/GPRS network to the UMA network.

2. Description of the Related Art

FIG. 1 illustrates a general Unlicensed Mobile Access (UMA) network. Referring to FIG. 1, the UMA network 110 provides a voice communication service or a data communication service using frequencies of an unpermitted band, such as in a Institute of Electrical and Electronics Engineers (IEEE) 802.11 system or a system using Bluetooth®, (hereinafter “Bluetooth”). The UMA network 110 provides a hand-in (A) function and a hand-out (B) function to the GSM/GPRS network 100 to thereby be connected with a mobile communication network. The UMA network includes an Unlicensed Wireless Network (UWN) and a UMA network controller (UNC). The UNC signifies a base station. “Hand-in” signifies that a mobile station (MS) executes handover from the GSM/GPRS network 100 to the UMA network 110 in the middle of voice communication. Conversely, handover of the mobile station from the UMA network 110 to the GSM/GPRS network 100 is referred to as “hand-out”.

FIG. 2 shows a signal flow of a hand-out process in a conventional UMA network. Referring to FIG. 2, a mobile station (MS) 200 is handed out from the UMA network 110 to the GSM/GPRS network 100. The mobile station 200 is in the state of “UMA Radio Resource—dedicated” (URR-dedicated) in step A), which is a state where a traffic channel is set up between the mobile station 200 and a media gateway (MGW) and voice packets can be exchanged based on a Real-time Transport Protocol (RTP).

In step B), a UNC 210 transmits a “URR uplink quality indication” message. The moment when the “URR uplink quality indication” message is determined based on an uplink quality algorithm of the UMA network 110. The “URR uplink quality indication” message is not always transmitted. When the network decides that the quality of its link with the mobile station 200 is low, the UNC 210 transmits the message to the mobile station 200 and informs the mobile station 200 of the deteriorated quality of the channel environment.

The mobile station 200 can also decide hand-out before the UNC 210 transmits the “URR uplink quality indication” message, and it has an algorithm for deciding the link quality on its own. With the algorithm, the mobile station 200 can transmit a “URR handover required” message which requests the UNC 210 for handover in step C).

The UNC 210 receives the “URR handover required” message, and transmits to the mobile station 200 a “URR handover command” message to execute handover in step D), in a normal state. The mobile station 200 executes hand-out into the GSM/GPRS network 100 upon receipt of the “URR handover command” message as response.

Subsequently, the mobile station 200 enters a “URR-registered” state, which is a state where the channel between the mobile station 200 and the media gateway transfers into the GSM/GPRS network 100 due to the handover and only registration information to the UNC 210 remains.

A typical algorithm for deciding handover including the case of FIG. 2 will now be described.

In the first place, handover may be determined based on the intensity of a received signal. When a UMA network adopts the IEEE 802.11 technology, the mobile station transforms the intensity of a signal transmitted from an access point (AP) into a Received Signal Strength Indication (RSSI) and checks the RSSI periodically. When the RSSI value is smaller than a predetermined threshold value, it is determined to perform handover.

Secondly, handover may be determined based on the average retransmission number. When the UMA network adopts the IEEE 802.11 technology, and an acknowledgement (Ack) is not received for one transmission packet, retransmission may be executed up to 7 times. The average retransmission number for packets transmitted during voice communication is accumulated and, when the accumulated value goes over a predetermined threshold value, it is determined to perform handover.

Thirdly, handover may be determined based on transmission loss rate. An algorithm of this method is more appropriate to an actual environment than the above-described two methods. When the UMA network adopts the IEEE 802.11 technology and an acknowledgement (Ack) is not received for one transmission packet even after retransmission is executed 7 times, the packet is regarded as a transmission loss. In this case, a transmission packet loss (Tx_Pkt_Loss) rate can be acquired as a ratio of the number of packets whose transmission is failed to the number of entire packets transmitted within a unit time, which is expressed as Equation 1. When the transmission packet loss rate is greater than a predetermined threshold value, it is determined to perform handover.

$$TX\_Pkt \_Loss = \frac{The\_Number \_of \_Tx \_failed \_Packets}{The\_Number \_of \_Total \_Tx \_Packets} \times 100 \qquad ( 1 )$$

The IEEE 802.11 wireless LAN protocol supports mobility less than the GSM protocol.

Whereas handover between GSM cells takes several to hundreds of milliseconds maximally, handover from a UMA Network (UMAN) cell to a GSM cell takes hundreds of milliseconds to almost one second. Thus, when a mobile station gets out of the UMA network fast, the handover success rate is remarkably low. Also, when the power source of an access point (AP), which executes the function of a base station in the UMA network, is turned off or reset abruptly in the middle of voice communication through the UMA network, the mobile station cannot execute hand-out into the GSM/GPRS network and a call may be dropped. This is because an algorithm triggering the handover is completely determined based on the handover algorithm of the mobile station and the link quality algorithm of the base station.

Therefore, current technology has a problem in that it cannot cope with a circumstance where a mobile station swiftly transfers from the UMA network to the GSM/GPRS network or where the power source of the AP is turned off or the setting of the AP is changed abruptly.

FIG. 3 is a flowchart of a hand-in process in the UMA network. Referring to FIG. 3, when handover is required in the state of the “URR-registered”, a mobile station 300 sets up a signal strength of the UMA network to be larger than that of the GSM/GPRS network in the measurement report message periodically transmitted to the GSM/GPRS network.

Since the UMA network has the largest signal strength among the cells in which the mobile station 300 can receive signals, the GSM/GPRS network directs the mobile station 300 to execute handover into the UMA network. Upon receipt of the direction, the mobile station 300 transmits a “URR handover access” message in step B which signifies that the mobile station 300 makes an access to a UNC 310.

The mobile station 300 enters a “URR-dedicated” state in step C). When a traffic channel is allocated to the mobile station 300 from the UNC 310 in step D), the mobile station 300 transmits a “URR handover complete” message that signifies the handover is completed in step E).

To begin the handover mechanism of FIG. 3, the mobile station 300 should be in the “URR-registered” mode. For this, the mobile station 300 searches for an access point (in a case where the IEEE 802.11 is used) that can access to the UNC 310. Generally, the mobile station 300 capable of using the UMA network has a search algorithm for searching for an access point.

When the search algorithm is a linear scanning algorithm, the mobile station 300 periodically searches for an access point on a unit-time basis. When the unit time is 1 minute, the mobile station 300 searches for the access point on a minute basis until the mobile station 300 enters the “URR-registered” state. This method, however, has a problem in that the mode of the mobile station 300 becomes “URR-registered” in a maximum of one minute after the mobile station enters the coverage of the access point.

When the search algorithm is a dynamic scanning algorithm, the mobile station 300 searches for an access point while varying its search period. When an access point is detected, the mobile station 300 shortens the search period. When no access point is detected, it lengthens the search period. Since the coverage of an access point is as small as the cell radius, and generally not wider than 100 m, the search period may be lengthened maximally when the mobile station 300 enters from an outdoor region without an access point. This method has a problem in that the mode of the mobile station 300 becomes “URR-registered” after a maximum time longer than that of the linear scanning algorithm, even though the mobile station 300 has already entered the coverage of the access point. In short, the delay time may increase a hand-in failure rate.

Therefore, an apparatus and method that can reduce a handover failure rate induced from an environment when hand-in and hand-out are executed is required.

### SUMMARY OF THE INVENTION

An aspect of the present invention is to substantially solve at least the above problems and/or disadvantages and to provide at least the advantages below. Accordingly, an aspect of the present invention is to provide a handover apparatus and method based on a user decision.

Another aspect of the present invention is to provide an apparatus and method for executing hand-out based on a user decision to prevent a hand-out failure from an Unlicensed Mobile Access (UMA) network to a Global System for Mobile Communication (GSM)/General Packet Radio Service (GPRS) network.

A further aspect of the present invention is to provide an apparatus and method for executing hand-out based on a user decision to prevent a hand-in failure from a UMA network to a GSM/GPRS network.

According to one aspect of the present invention, a method for executing hand-out from a UMA network into a GSM/GPRS network in a mobile station includes checking if there is an input of a hand-out key directing hand-out into the GSM/GPRS network from a user while voice communication is executed in a mode dedicated to the UMA network; upon sensing the input of a hand-out key into the GSM/GPRS network; providing a handover request message for hand-out to a base station of the UMA network and receiving a handover command message in response, upon receipt of the handover command message; and executing handover into the GSM/GPRS network.

According to another aspect of the present invention, there is provided a method for executing hand-in from a GSM/GPRS network into a UMA network in a mobile station. The method includes checking if there is an input of a hand-in key directing hand-in into the UMA network from a user while voice communication is executed through the GSM/GPRS network; searching for an access point (AP) and accessing the access point; registering the mobile station to a base station of the UMA network; transmitting a handover access message to the base station of the UMA network; setting up a traffic channel by switching the registration mode into a dedicated mode after the transmission of the handover access message; and completing the handover by transmitting a handover completion message to the base station of the UMA network

According to a further aspect of the present invention, there is provided a mobile station for executing handover between a GSM/GPRS network and a UMA network. The mobile station includes an input unit for providing user direction input for hand-in or hand-out; a handover processor for processing, analyzing, and generating a message for the hand-in or hand-out according to the direction; transmitting the generated message through an interface module; and executing hand-in into the UMA network or hand-out into the GSM/GPRS network.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a general Unlicensed Mobile Access (UMA) network;

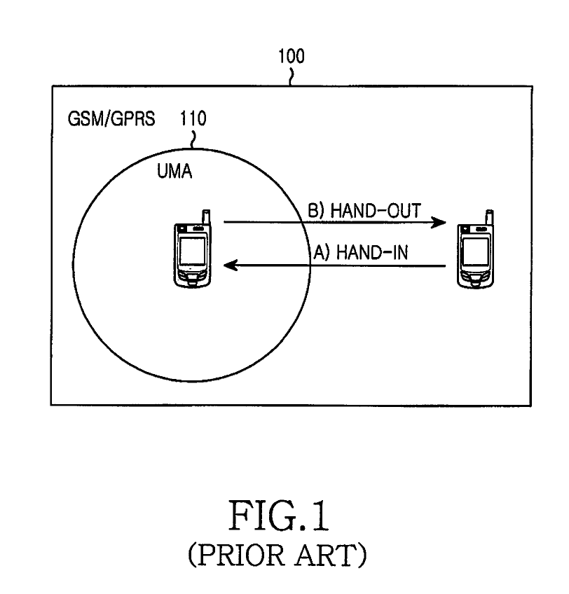

FIG. 2 shows a signal flow diagram of a hand-out process in a conventional UMA network;

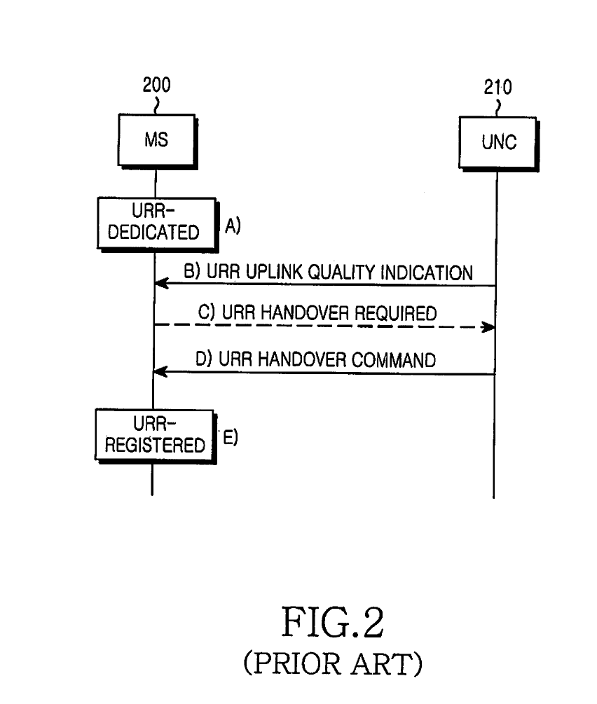

FIG. 3 shows a signal flow diagram of a conventional hand-in process in the UMA network;

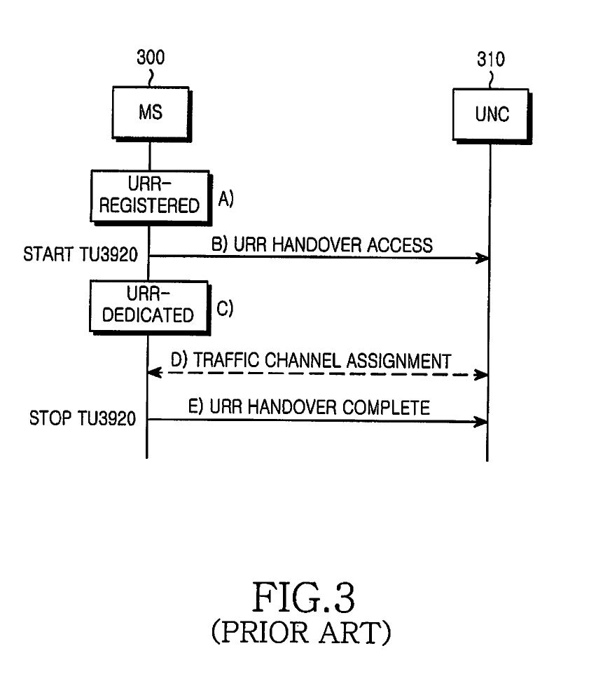

FIG. 4 shows a signal flow diagram of a hand-out process based on a user decision in the UMA network according to the present invention;

FIG. 5 shows a signal flow diagram of a hand-in process based on a user decision in the UMA network according to the present invention;

FIG. 6 is a flowchart of a hand-out process based on a user decision in the UMA network according to the present invention;

FIG. 7 is a flowchart of a hand-in process based on a user decision in the UMA network according to the present invention; and

FIG. 8 is a block diagram of a mobile station in the UMA network according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

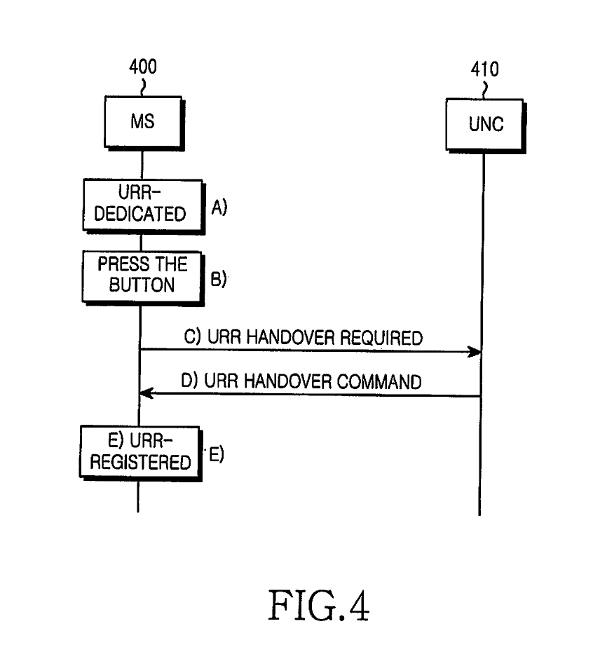

FIG. 4 shows a signal flow of a hand-out process based on a user decision in a Unlicensed Mobile Access (UMA) network according to the present invention. Referring to FIG. 4, a mobile station 400 is assumed to be in a “URR-dedicated” mode in step A). In other words, the mobile station 400 is on line in voice communication through the UMA network. A user recognizes from the screen of the mobile station 400 that voice communication is executed through the UMA network.

Subsequently, when the user attempts to turn off the power source of an access point or go out of the coverage area of the access point abruptly, such as, to go from one room to another room and change the position of the access point from the first room to the other room, the user presses a dedicated button or key, such as a volume control button disposed on the right side of the mobile station, in the middle of the voice communication in step B).

The volume control button signifies a hand-out key into a Global System for Mobile Communication (GSM)/General Packet Radio Service (GPRS) network during the communication. When the dedicated button is pressed, the mobile station 400 executes the hand-out process through steps C), D) and E). In short, upon sensing the input of the hand-out key from the user, the mobile station 400 transmits a “URR handover required” message to begin the hand-out process.

The hand-out key may be provided on the mobile station 400 as an additional key, or it may be implemented by providing some software function to a conventional button.

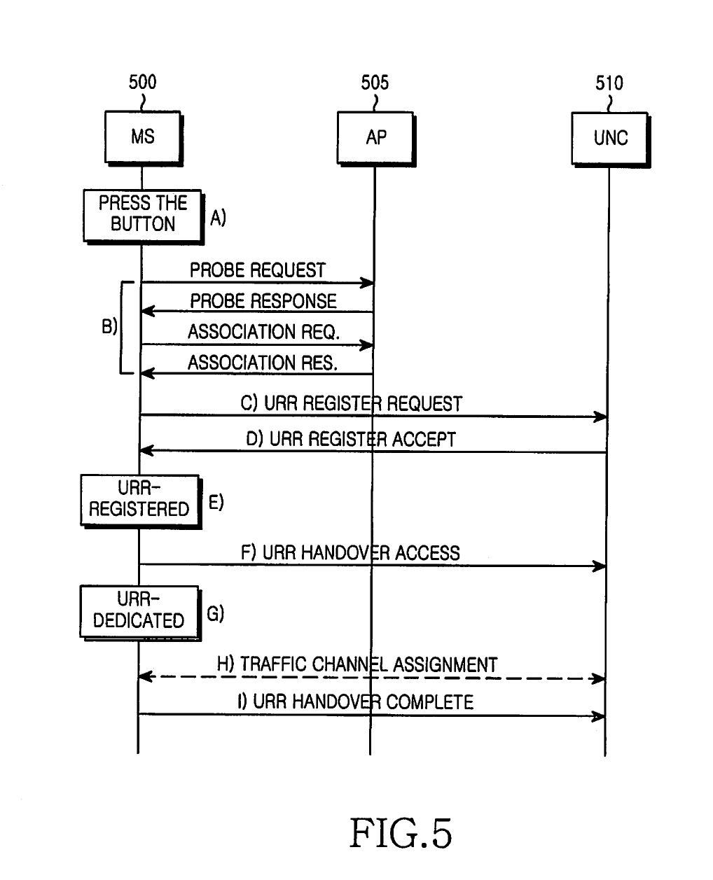

FIG. 5 shows a signal flow of a hand-in process based on a user decision in the UMA network according to the present invention. Referring to FIG. 5, it is assumed that the user enters his/her house with an access point set up therein while performing voice communication through the GSM/GPRS network. The user recognizes in step A) that he/she is within the coverage area of the access point and presses a hand-in key.

Upon sensing the input of the hand-in key from the user, a mobile station 500 executes searching for an access point and accessing to the access point in step B), and performs a process for entering a “URR-registered” mode in steps C) and D).

Subsequently, the mobile station 500 enters the “URR-registered” mode in steps E) and transmits a “URR handover access” message which signifies that the mobile station 500 executes access for handover to a UNC 510 in step F).

When the mobile station 500 enters a “URR-dedicated” state in step G) and a traffic channel is allocated to the mobile station 500 from the UNC 510 in step H), it transmits a “URR handover complete” message which signifies that the mobile station 500 has completed the handover in step I).

The hand-in key may be provided on the mobile station 500 as an additional key, or it may be implemented by providing some software function to a conventional button.

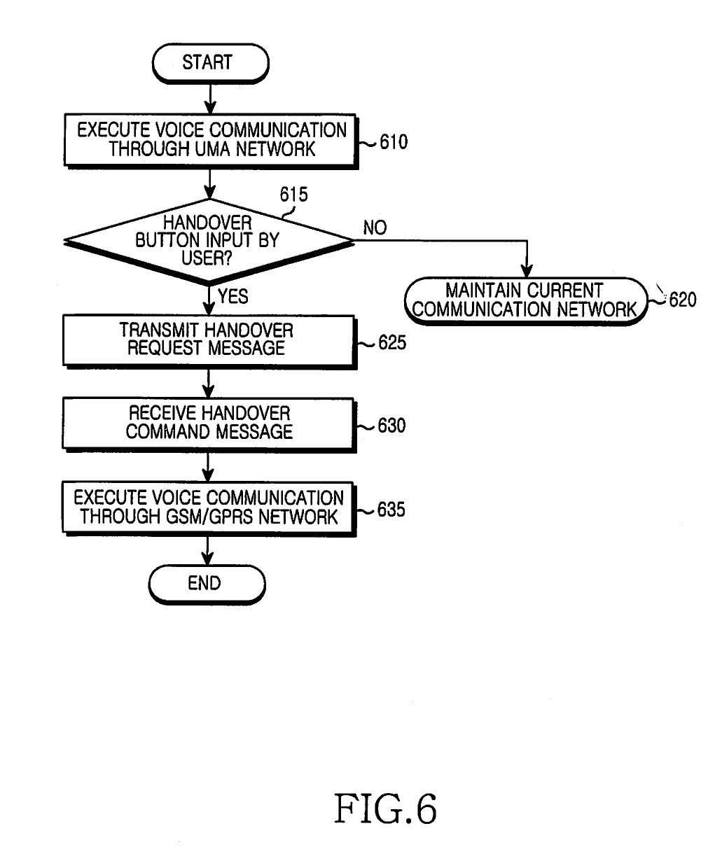

FIG. 6 is a flowchart of a hand-out process based on a user decision in the UMA network according to the present invention. Referring to FIG. 6, it is assumed that a mobile station is in a “URR-dedicated” mode in step 610. In other words, the mobile station is on line in voice communication through the UMA network. A user recognizes from the screen of the mobile station that voice communication is executed through the UMA network.

Subsequently, when the user attempts to turn off the power source of an access point or go out of the coverage area of the access point abruptly to go from one room to another room and change the position of the access point from the first room to the other room, the user presses a dedicated button or key, such as a volume control button disposed on the right side of the mobile station, in the middle of the voice communication in step 615.

The volume control button signifies a hand-out key into a GSM/GPRS network during the communication. When the volume control button is pressed, the mobile station transmits a “URR handover required” message to request handover and executes the hand-out process by receiving a “URR handover command” message in steps 625 and 630, respectively.

Subsequently, the user can perform voice communication with the mobile station through the GSM/GPRS network in step 635.

When the user does not press the hand-out key into the GSM/GPRS network for continuous voice communication through the UMA network, the mobile station continues the voice communication through the current network in step 620.

In short, the mobile station begins the hand-out process only after it senses the input of the hand-out key from the user. The hand-out key may be provided to the mobile station as an additional key, or it may be implemented by providing some software function to a conventional button. Subsequently, the algorithm of the present invention ends.

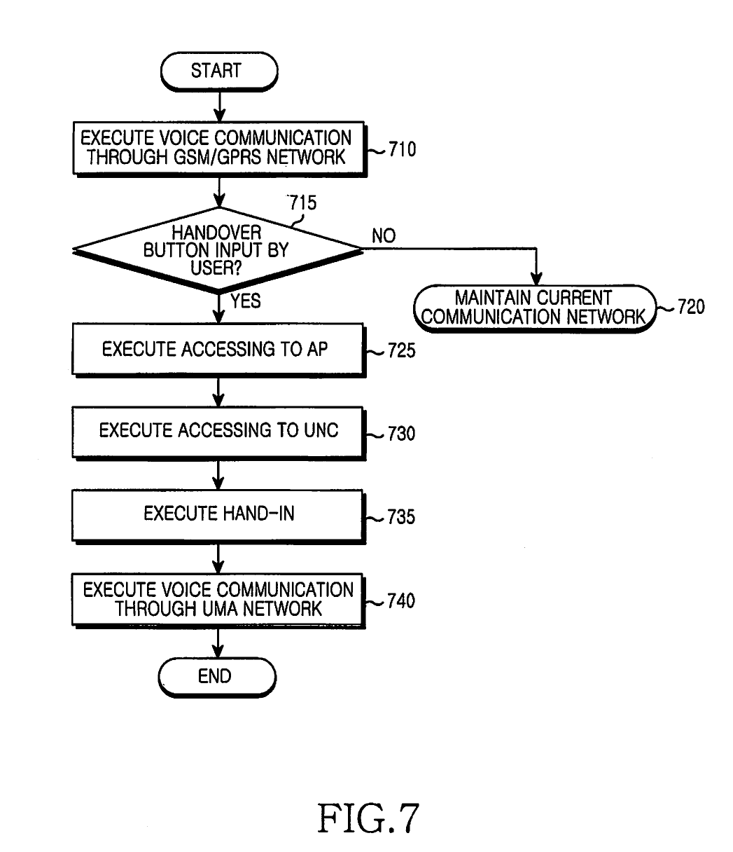

FIG. 7 is a flowchart of a hand-in process based on a user decision in the UMA network according to the present invention. Referring to FIG. 7, it is assumed that the user enters his/her house with an access point set up therein while performing voice communication through the GSM/GPRS network. The user recognizes in step 715 that he/she is within the coverage area of the access point and presses a hand-in key.

Upon sensing the input of the hand-in key from the user, a mobile station searches for an access point and accesses the access point in step 725, and performs a process for entering a “URR-registered” mode in steps 730.

Subsequently, the mobile station enters the “URR-registered” state and transmits a “URR handover access” message which signifies that the mobile station executes access for handover to a UNC in step 735.

When the mobile station enters a “URR-dedicated” mode and a traffic channel is allocated to the mobile station from the UNC, it transmits a “URR handover complete” message which signifies that the mobile station has completed the handover and the hand-in process is completed.

Subsequently, the user can perform voice communication with the mobile station through the UMA network in step 740.

When the user does not press the hand-in key into the UMA network in step 715, the mobile station continuously performs voice communication through the current network in step 720. Subsequently, the algorithm of the present invention ends.

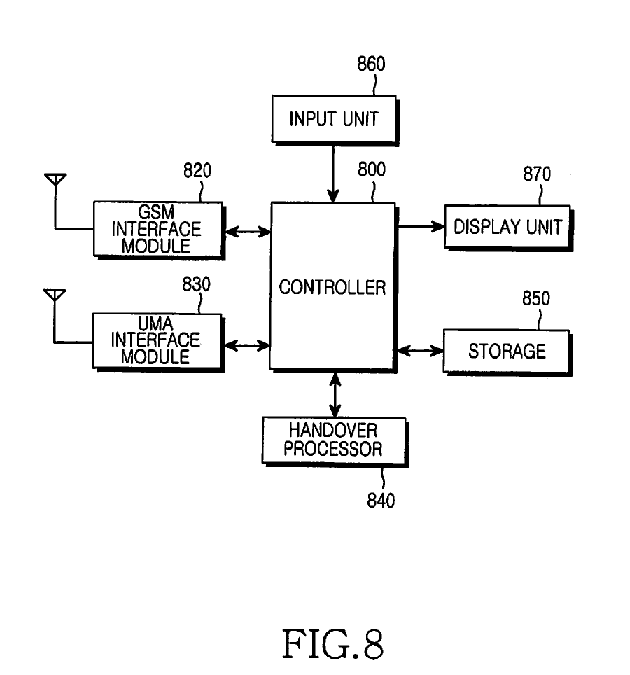

FIG. 8 illustrates a block diagram of a mobile station in the UMA network according to the present invention. Referring to FIG. 8, a controller 800 makes a handover processor 840 execute hand-in or hand-out according to the present invention, in addition to its conventional function of executing voice communication or data communication and managing the functions of the mobile station.

The handover processor 840 receives an instruction for hand-in or hand-out and analyzes and processes the instruction when a user inputs a hand-in or hand-out button, and it generates corresponding messages to thereby execute hand-in into the UMA network or hand-out into the GSM/GPRS network. The process includes the on/off function and driving of a GSM interface module 820 and a UMA interface module 830 according to hand-in or hand-out. In short, the handover processor 840 is in charge of general functions needed for hand-in and hand-out.

A storage 850 stores a program for controlling the general operation of the apparatus of the present invention and stores temporary data generated in the middle of execution of the program.

The GSM interface module 820 is used for communication of the mobile station through the GSM/GPRS network, and includes a Radio Frequency (RF) processor and a baseband processor. The RF processor converts signals received through an antenna into baseband signals and provides the baseband signals to the baseband processor. It also converts baseband signals from the baseband processor into RF signals, which can be transmitted over the air, and transmits the RF signals through the antenna.

The UMA interface module 830 is used for communication of the mobile station through the UMA network, and includes an RF processor and a baseband processor. The RF processor converts signals received through an antenna into baseband signals and provides the baseband signals to the baseband processor. It also converts baseband signals from the baseband processor into RF signals, which can be transmitted over the air, and transmits the RF signals through the antenna.

An input unit 860 is a part corresponding to a keypad of a mobile station. According to the present invention, a specific button for executing the hand-in or hand-out function may be provided with the input unit 860. Also, one of the conventional buttons may be used as the button for executing the hand-in or hand-out function.

A display unit 870 displays the type of current network other than typical outputs of the mobile station.

In the above structure, the controller 800 may execute the function of the handover processor 840. However, the functions of the controller 800 and the handover processor 840 are presented in different constituent elements to distinctively describe the functions one from another. Therefore, when an actual product is implemented, the entire function or part of the function of the handover processor 840 may be executed in the controller 800.

As described above, the apparatus and method of the present invention increases a handover success rate in the mobile station and executes seamless voice communication by allowing a user to directly decide a handover moment, when hand-out into the GSM/GPRS network or a hand-in into the UMA network is executed. Also, since the user can freely switch networks whenever the user wants, there is an advantage in that the user does not have to wait as long as the maximum search time in the execution of hand-in.

Alternate embodiments of the present invention can also comprise computer readable codes on a computer readable medium. The computer readable medium includes any data storage device that can store data that can be read by a computer system. Examples of a computer readable medium include magnetic storage media (such as ROM, floppy disks, and hard disks, among others), optical recording media (such as CD-ROMs or DVDs), and storage mechanisms such as carrier waves (such as transmission through the Internet). The computer readable medium can also be distributed over network coupled computer systems so that the computer readable code is stored and executed in a distributed fashion. Also, functional programs, codes, and code segments for accomplishing the present invention can be construed by programmers of ordinary skill in the art to which the present invention pertains.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for executing hand-out from a Unlicensed Mobile Access (UMA) network into a Global System for Mobile Communication (GSM)/General Packet Radio Service (GPRS) network in a mobile station, comprising:
determining if there is an input of a hand-out key directing hand-out;
transmitting a handover request message to a base station of the UMA network, upon sensing of the input of the hand-out key; and
executing handover into the GSM/GPRS network upon receipt of the handover command message as response.

2. The method of claim 1, wherein executing handover into the GSM/GPRS network comprises, switching from a dedicated mode to a registered mode upon the receipt of the handover command message, and executing handover into the GSM/GPRS network.

3. A method for executing hand-in from a GSM/GPRS network into a UMA network in a mobile station, comprising:
determining if there is an input of a hand-in key directing hand-in;
searching for an access point (AP) upon sensing of the input of a hand-in key;
registering the mobile station to a base station of the UMA network upon accessing the access point;
transmitting a handover access message to the base station of the UMA network upon the registration;
setting up a traffic channel by switching the registration mode into a dedicated mode after the transmission of the handover access message; and
completing the handover by transmitting a handover completion message to the base station of the UMA network upon the setup of the traffic channel.

4. A mobile station for handover between a GSM/GPRS network and a UMA network, comprising:
an input unit for providing input for hand-in or hand-out;
a GSM interface module for communication to the GSM/GPRS network;
a UMA interface module for communication to the UMA network; and
a handover processor for determining if there is an input of a hand-out key, transmitting a handover request message to a base station of the UMA network upon sensing of the input of the hand-out key, and executing handover into the GSM/GPRS network upon receipt of a handover command message as response.

5. The mobile station of claim 4, wherein the handover processor comprises, determining if there is an input of a hand-in key, searching for an access point upon sensing of the input of a hand-in key, registering the mobile station to a base station of the UMA network upon accessing the access point, transmitting a handover access message to the base station of the UMA network upon the registration, setting up a traffic channel by switching the registration mode into a dedicated mode after the transmission of the handover access message, and completing the handover by transmitting a handover completion message to the base station of the UMA network upon the setup of the traffic channel.

6. The mobile station of claim 4, wherein the input unit includes one of a button for hand-in or hand-out, and an implemented conventional button provided with a software function for hand-in or hand-out at one of conventional buttons for providing hand-in or hand-out direction.

7. A mobile station for handover between a GSM/GPRS network and a UMA network, comprising:
means for determining if there is an input of a hand-out key;
means for transmitting a handover request message to a base station of the UMA network, upon sensing of the input of the hand-out key; and
means for executing handover into the GSM/GPRS network upon receipt of the handover command message as response.

8. The mobile station of claim 7, wherein the means for executing handover into the GSM/GPRS network comprises,
means for switching from a dedicated mode to a registered mode upon the receipt of the handover command message; and
means for executing handover into the GSM/GPRS network.

9. A mobile station for handover between a GSM/GPRS network and a UMA network, comprising:
means for determining if there is an input of a hand-in key;
means for searching for an access point (AP) upon sensing of the input of a hand-in key;
means for registering the mobile station to a base station of the UMA network upon accessing the access point;
means for transmitting a handover access message to the base station of the UMA network upon the registration;
means for setting up a traffic channel by switching the registration mode into a dedicated mode after the transmission of the handover access message; and
means for completing the handover by transmitting a handover completion message to the base station of the UMA network upon the setup of the traffic channel.
